(19) United States
(12) Patent Application Publication
(10) Pub. No.: US 2026/0353075 A1
(43) Pub. Date: Nov. 5, 2026

(54) AUTHENTICATION ENHANCEMENTS FOR PERSONAL IOT NETWORKS

(71) Applicant: Apple Inc., Cupertino, CA (US)

(72) Inventors: Behrouz AGHILI, Poway, CA (US); Sudeep Manithara VAMANAN, Uttenreuth (DE)

(21) Appl. No.: 19/102,827

(22) PCT Filed: Jul. 7, 2023
(86) PCT No.: PCT/US2023/069824

§ 371 Date: Feb. 10, 2025

Related U.S. Application Data
(60) Provisional application No. 63/396,832, filed on Aug. 10, 2022.

(51) Int. Cl. H04W 12/06; H04W 12/084

(52) U.S. Cl. CPC H04W 12/06; H04W 12/084

(57) ABSTRACT

Methods and apparatuses are disclosed to enhance authentication and security for personal IoT networks (PINs). In an example embodiment, a gateway of the PIN performs operations including: transmitting to an access mobility function (AMF) entity a subscriber identifier of the gateway and a subscriber identifier for each of a plurality of user equipments (UEs) in a registration request; receiving an authentication request from the AME including a random number (RAND) and an authentication token, wherein the RAND is associated with both the gateway and the UEs; verifying the authentication token; calculating a gateway authentication response; transmitting the RAND to the UEs; receiving an authentication response from each of the UEs based on the RAND; transmitting an authentication response to the AMP including the gateway authentication response and the authentications responses from each of the UEs; and accepting registration of the gateway and the plurality of UEs by the AME entity.

### CROSS-REFERENCE TO RELATED APPLICATIONS

This application claims priority to U.S. Provisional Application Ser. No. 63/396,832 filed 10 Aug. 2022, the entire contents of which are incorporated herein by reference.

FIELD OF INVENTION This invention relates generally to the field of wireless communication, and more particularly, to apparatuses and methods for enhancing authentication and security for personal IoT networks (PINs) in a communication network. Other aspects are also described.

### BACKGROUND OF THE INVENTION

The use and complexity of wireless systems, which include 4^{th} generation (4G) and 5^{th} generation (5G) networks among others, has increased due to both an increase in the types of user equipment (UE) devices using network resources as well as the amount of data and bandwidth being used by various applications, such as video streaming, operating on these UEs. With the vast increase in the number and diversity of communication devices, the corresponding network environment, including routers, switches, bridges, gateways, firewalls, and load balancers, has become increasingly complicated, especially with the advent of next generation (NG) (or new radio (NR) systems).

At the same time, Personal Internet of Thing (IoT) Networks (PINs) including one or more PIN elements that communicate with each other are being rapidly developed. A PIN Element (PINE) may be considered to be a basic component making up a PIN-a User's Personal IoT Network. A PINE may be an IoT Device, a UE, or any type of device that communicates within the PIN network, with other PINEs, and through a gateway or another component with outside networks. It should be appreciated that the Internet of Things (IoT) describes the network of physical objects—“things”—IoT devices that are embedded with sensors, software, and other technologies for the purpose of connecting and exchanging data with other devices and systems over wired networks, wireless networks, the Internet, etc. Thus, an IoT device may be most any type of computing device. Traditional IoT capabilities have been designed for traditional IoT devices that communicate using the cellular network, such as, battery constrained devices where it is expected that the battery should last in the order of years. Localized personal IoT devices such as wearable devices and home automation devices are increasing being used in Personal IoT networks (PINs). For example, a wide variety of wearable IoT devices can be locally used: glasses frames, earbuds, blood pressure monitor, pacemaker, rings. Common IoT devices include: wireless sensor networks, control system networks, “smart home” devices-including devices and appliances (such as, lighting fixtures, thermostats, home security systems, cameras, and other home appliances). This being a very small limited example list of IoT devices for use in a PIN.

A PIN Element with a gateway capability can act as a gateway that provides access to and from the public operators network (fixed/mobile/cable) and a PIN. As an example, a PIN element can have both PIN management capability and gateway capability. A gateway provides the bridge between IoT devices in the personal field, the cloud, and other user equipment such as smartphones. A gateway PINE may be denoted as a PINEG.

Because all of PINEs in a PIN need to registered and authenticated with a network, the number of procedures, as well as signaling messages, can become considerably high. With the advancement of PIN technologies, the procedures currently utilized for authentication and security are inefficient. Therefore, methods to optimize both registration and authentication are sought after.

### SUMMARY OF THE DESCRIPTION

Methods and apparatuses are disclosed to enhance and optimize authentication and security procedures for personal IoT networks (PINs) in a communication network. In particular, several devices may be authenticated during one and the same procedure—instead of running several parallel separate procedures as is currently done—by using a gateway device and modifying signaling procedures, as will be described. As will be described, methods and apparatuses to optimize both registration and authentication are disclosed.

In an example embodiment, a gateway of a communication network is disclosed that includes: at least one antenna; at least one radio, wherein the at least one radio is configured to communicate with the communication network using the at least one antenna, and at least one processor coupled to the at least one radio. The at least one processor may be configured to perform operations including: transmitting to an access mobility function (AMF) entity a subscriber identifier of the gateway and a subscriber identifier for each of a plurality of user equipments (UEs) in a registration request; receiving an authentication request from the AMF including a random number (RAND) and an authentication token (AUTN), wherein the RAND is associated with both the gateway and the UEs; verifying the authentication token; calculating a gateway authentication response; and transmitting the RAND to the UEs. The processor of the gateway further: receives an authentication response from each of the UEs based on the RAND; transmits an authentication response to the AMF including the gateway authentication response and the authentications responses from each of the UEs; and then accepts registration of the gateway and the plurality of UEs by the AMF entity.

In some embodiments, the plurality of UEs and the gateway are configured to communicate in a Personal IoT Network (PIN). The subscriber identifiers for each of the plurality of UEs may be transmitted to the AMF of the communication network in the registration request in a sequential order. The authentication token may be verified by implementing an authentication token parameter check. The authentication request from the AMF may further include a bitmap identifying UEs to be authenticated in a sequential order. Further, the authentication response transmitted to the AMF including the gateway authentication response and the authentications responses from each of the UEs may include the responses from the UEs ordered in the same sequential order as in the bitmap of the authentication request.

In another example embodiment, a method to authenticate a plurality of user equipments (UEs) with an access mobility function entity (AMF) of a communication network is disclosed. The method includes: transmitting to the AMF of the communication network a subscriber identifier of a gateway and a subscriber identifier for each of the plurality of user equipments (UEs) in a registration request; receiving an authentication request from the AMF including a random number (RAND) and an authentication token, wherein the RAND is associated with both the gateway and the UEs; verifying the authentication token; calculating a gateway authentication response; and transmitting the RAND to the UEs. The method further includes: receiving an authentication response from each of the UEs based on the RAND; and transmitting an authentication response to the AMF including the gateway authentication response and the authentications responses from each of the UEs. The method can then accept registration of the gateway and the plurality of UEs by the AMF of the communication network.

In some embodiments, the plurality of UEs and the gateway are configured to communicate in a Personal IoT Network (PIN). The subscriber identifiers for each of the plurality of UEs are transmitted to the AMF of the communication network in the registration request in a sequential order. The authentication token is verified by implementing an authentication token parameter check. The authentication request from the AMF may include a bitmap identifying UEs to be authenticated in a sequential order. Further, the authentication response transmitted to the AMF including the gateway authentication response and the authentications responses from each of the UEs includes the responses from the UEs ordered in the same sequential order as in the bitmap of the authentication request.

In another example embodiment a user equipment (UE) including: at least one antenna; at least one radio, wherein the at least one radio is configured to communicate with a communication network using the at least one antenna; and at least one processor coupled to the at least one radio is disclosed. The at least one processor may be configured to perform operations including: receiving a random number (RAND) from a gateway, wherein, the RAND is received from the gateway in an authentication request from an access mobility function entity (AMF) of a communication network, wherein, the RAND is associated with both the gateway, the UE, and a plurality of other UEs associated with the gateway based upon a registration request from the gateway to the AMF including subscriber identifiers of the gateway, the UE, and the plurality of other UEs; computing an authentication response to the AMF based upon the RAND; and transmitting the authentication response to the gateway, wherein the gateway transmits an authentication response to the AMF that includes an authentication response of the gateway and authentication responses of the UEs. In some embodiments, the UE, the plurality of other UEs, and the gateway are configured to communicate in a Personal IoT Network (PIN). The subscriber identifiers for the UE and the plurality of other UEs in the registration request to the AMF of the communication network are in a sequential order. Further, the authentication request from the AMF may further include a bitmap identifying UEs to be authenticated in a sequential order.

In a further example embodiment, a baseband processor of a wireless user equipment (UE) of a communication network may be configured to: receive a random number (RAND) from a gateway, wherein, the RAND is received from the gateway in an authentication request from an access mobility function entity (AMF) of the communication network, wherein, the RAND is associated with both the gateway and UEs associated with the gateway based upon a registration request from the gateway to the AMF including subscriber identifiers of the gateway, the UE, and the plurality of other UEs; compute an authentication response to the AMF based upon the RAND; and transmit the authentication response to the gateway, wherein the gateway transmits an authentication response to the AMF, wherein the authentication response includes an authentication response of the gateway and authentication responses of the UEs. In some embodiments, the UE, the plurality of other UEs, and the gateway may be configured to communicate in a Personal IoT Network (PIN). The subscriber identifiers for the UE and the plurality of other UEs in the registration request to the AMF of the communication network are in a sequential order. The authentication request from the AMF may include a bitmap identifying UEs to be authenticated in a sequential order.

In an additional example embodiment, a baseband processor of a gateway of a communication network may be configured to perform operations including: transmitting to an access mobility function entity (AMF) of the communication network a subscriber identifier of the gateway and a subscriber identifier for each of a plurality of user equipments (UEs) in a registration request; receiving an authentication request from the AMF including a random number (RAND) and an authentication token, wherein the RAND is associated with both the gateway and the UEs; verifying the authentication token; calculating a gateway authentication response; transmitting the RAND to the UEs. The baseband processor may further perform operations including: receiving an authentication response from each of the UEs based on the RAND; transmitting an authentication response to the AMF including the gateway authentication response and the authentications responses from each of the UEs; and accepting registration of the gateway and the plurality of UEs by the AMF of the communication network. In some embodiments, the plurality of UEs and the gateway are configured to communicate in a Personal IoT Network (PIN). The subscriber identifiers for each of the plurality of UEs may be transmitted to the AMF of the communication network in the registration request in a sequential order. The authentication token may be verified by implementing an authentication token parameter check. The authentication request from the AMF may further include a bitmap identifying UEs to be authenticated in a sequential order. Further, the authentication response transmitted to the AMF including the gateway authentication response and the authentications responses from each of the UEs may include the responses from the UEs ordered in the same sequential order as in the bitmap of the authentication request.

In a further type of example embodiment, a gateway of a communication network is disclosed that includes: at least one antenna; at least one radio, wherein the at least one radio is configured to communicate with a communication network using the at least one antenna; and at least one processor coupled to the at least one radio. The at least one processor may be configured to perform operations that include: transmitting to an access mobility function entity (AMF) of the communication network a subscriber identifier of a gateway and a subscriber identifier for each of a plurality of user equipments (UEs) in a registration request; receiving an authentication request from the AMF including a RAND associated with the gateway, a random number (RAND) associated with each UE, respectively, and an authentication token corresponding to the RAND associated with the gateway; verifying the authentication token; calculating a gateway authentication response; and transmitting each RAND associated with each UE, to each UE, respectively. Further, under the control of the at least one processor: receiving an authentication response from each of the UEs, based on each UE's RAND; transmitting an authentication response to the AMF including the gateway authentication response and the authentication responses from each of the UEs, respectively; and accepting registration of the gateway and the plurality of UEs by the AMF of the communication network.

In some embodiments, the plurality of UEs and the gateway are configured to communicate in a Personal IoT Network (PIN). The subscriber identifiers for each of the plurality of UEs may be transmitted to the AMF of the communication network in the registration request in a sequential order. The authentication token may be verified by implementing an authentication token parameter check. After the authentication token is verified, the UEs may be informed that the authentication token was verified.

In a further embodiment, a method to authenticate a plurality of user equipments (UEs) with an access mobility function entity (AMF) of a communication network is disclosed. The method includes the operations of: transmitting to the AMF of the communication network a subscriber identifier of a gateway and a subscriber identifier for each of the plurality of user equipments (UEs) in a registration request; receiving an authentication request from the AMF including a RAND associated with the gateway, a random number (RAND) associated with each UE, respectively, and an authentication token corresponding to the RAND associated with the gateway; verifying the authentication token at the gateway; calculating a gateway authentication response; transmitting each RAND associated with each UE, to each UE, respectively; receiving an authentication response from each of the UEs, based on each UE's RAND. The method further includes the operations of: transmitting an authentication response to the AMF including the gateway authentication response and the authentication responses from each of the UEs, respectively; and accepting registration of the gateway and the plurality of UEs by the AMF of the communication network. In some embodiments, the plurality of UEs and the gateway are configured to communicate in a Personal IoT Network (PIN). The subscriber identifiers for each of the plurality of UEs may be transmitted to the AMF of the communication network in the registration request in a sequential order. The authentication token may be verified by implementing an authentication token parameter check. Further, after the authentication token is verified, the UEs may be informed that the authentication token was verified.

In an additional embodiment, a user equipment (UE) is disclosed that comprises: at least one antenna; at least one radio, wherein the at least one radio is configured to communicate with a communication network using the at least one antenna; and at least one processor coupled to the at least one radio. The at least one processor is configured to perform operations including: receiving a random number (RAND) associated with the UE, wherein, the RAND for the UE is received from the gateway in an authentication request from an access mobility function entity (AMF) of a communication network based upon a registration request from the gateway to the AMF including subscriber identifiers of the gateway, the UE, and a plurality of other UEs; computing an authentication response to the AMF based upon the RAND; and transmitting the authentication response to the gateway, wherein the gateway transmits an authentication response to the AMF, wherein the authentication response includes an authentication response of the gateway and authentication responses of the UEs. In some embodiments, the plurality of UEs and the gateway are configured to communicate in a Personal IoT Network (PIN). The subscriber identifiers for each of the plurality of UEs may be transmitted to the AMF of the communication network in the registration request in a sequential order. After the authentication token is verified by the gateway, the UE may be informed that the authentication token was verified.

In another embodiment, a baseband processor of a wireless user equipment (UE) of a communication network may be configured to perform operations including: receiving a random number (RAND) associated with the UE, wherein, the RAND for the UE is received from the gateway in an authentication request from an access mobility function entity (AMF) of a communication network based upon a registration request from the gateway to the AMF including subscriber identifiers of the gateway, the UE, and the plurality of other UEs; computing an authentication response to the AMF based upon the RAND; and transmitting the authentication response to the gateway, wherein the gateway transmits an authentication response to the AMF, and wherein the authentication response includes an authentication response of the gateway and authentication responses of the UEs. In some embodiments, the plurality of UEs and the gateway are configured to communicate in a Personal IoT Network (PIN). The subscriber identifiers for each of the plurality of UEs may be transmitted to the AMF of the communication network in the registration request in a sequential order. After the authentication token is verified by the gateway, the UE may be informed that the authentication token was verified.

In yet another embodiment, a baseband processor of a gateway of a communication network configured to perform operations including: transmitting to an access mobility function entity (AMF) of the communication network a subscriber identifier of a gateway and a subscriber identifier for each of a plurality of user equipments (UEs) in a registration request; receiving an authentication request from the AMF including a RAND associated with the gateway, a random number (RAND) associated with each UE, respectively, and an authentication token corresponding to the RAND associated with the gateway; verifying the authentication token; calculating a gateway authentication response transmitting each RAND associated with each UE, to each UE, respectively; and receiving an authentication response from each of the UEs, based on each UE's RAND. The baseband processor of the gateway may further perform operations including: transmitting an authentication response to the AMF including the gateway authentication response and the authentication responses from each of the UEs, respectively; and accepting registration of the gateway and the plurality of UEs by the AMF of the communication network. In some embodiments, the plurality of UEs and the gateway are configured to communicate in a Personal IoT Network (PIN). The subscriber identifiers for each of the plurality of UEs are transmitted to the AMF of the communication network in the registration request in a sequential order. The authentication token may be verified by implementing an authentication token parameter check. After the authentication token is verified, the UEs may be informed that the authentication token was verified.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to one embodiment of the disclosure.

FIG. 2 illustrates user equipment in direct communication with a base station (BS) according to one embodiment of the disclosure.

FIG. 3 illustrates an example block diagram of a UE according to one embodiment of the disclosure.

FIG. 4 illustrates an example block diagram of a BS according to one embodiment of the disclosure.

FIG. 5 illustrates an example block diagram of cellular communication circuitry according to one embodiment of the disclosure.

FIG. 6 illustrates a scenario for a gateway in a Personal Internet of Things (IoT) network (a PIN network) to communicate with a core network in a wireless communication network to register and authenticate the gateway and a plurality of UEs according to one embodiment of the disclosure.

FIG. 7 is a flow chart illustrating a process for the gateway to register and authenticate IoT devices and UEs with the core network according to one embodiment of the disclosure.

FIG. 8 is a more detailed flow diagram illustrating a process for a gateway to register and authenticate IoT devices and UEs with an AMF of the core network according to one embodiment of the disclosure.

FIG. 9 is a flow chart illustrating a process for the gateway to register and authenticate IoT devices and UEs with a core network according to another embodiment of the disclosure.

FIG. 10 is a more detailed flow diagram illustrating a process for a gateway to register and authenticate IoT devices and UEs with an AMF of the core network according to one embodiment of the disclosure.

### DETAILED DESCRIPTION

Methods and apparatuses are disclosed to enhance and optimize authentication and security procedures for personal IoT networks (PINs) in a communication network. In particular, several devices may be authenticated during one and the same procedure-instead of running several parallel separate procedures as is currently done-by using a gateway device and modifying signaling procedures, as will be described. As will be described, methods and apparatuses to optimize both registration and authentication are disclosed.

In an example embodiment, a gateway of a communication network is disclosed that includes: at least one antenna; at least one radio, wherein the at least one radio is configured to communicate with the communication network using the at least one antenna, and at least one processor coupled to the at least one radio. The at least one processor may be configured to perform operations including: transmitting to an access mobility function (AMF) entity a subscriber identifier of the gateway and a subscriber identifier for each of a plurality of user equipments (UEs) in a registration request; receiving an authentication request from the AMF including a random number (RAND) and an authentication token, wherein the RAND is associated with both the gateway and the UEs; verifying the authentication token; calculating a gateway authentication response; and transmitting the RAND to the UEs. The processor of the gateway further: receives an authentication response from each of the UEs based on the RAND; transmits an authentication response to the AMF including the gateway authentication response and the authentications responses from each of the UEs; and then accepts registration of the gateway and the plurality of UEs by the AMF entity.

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” means that a particular feature, structure, or characteristic described in connection with the embodiment can be included in at least one embodiment of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

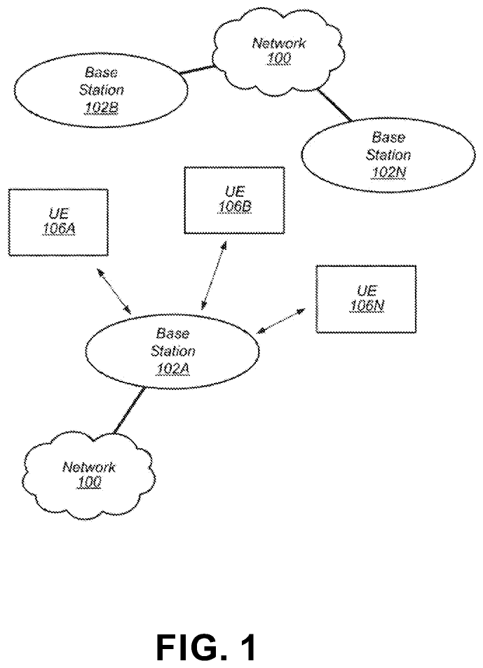

FIG. 1 illustrates a simplified example wireless communication system according to one aspect of the disclosure. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA 2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA 2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

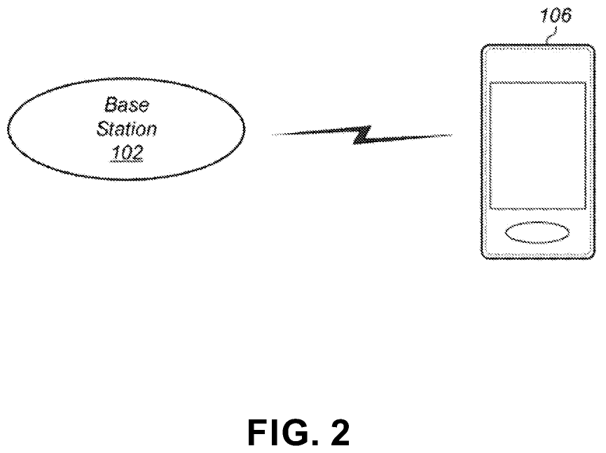

FIG. 2 illustrates a UE 106 in direct communication with a base station 102 through uplink and downlink communications according to one aspect of the disclosure. The UE 106 may be a device with cellular communication capability such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/cHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTTor LTE or GSM), and separate radios for communicating using each of Wi-Fi and Bluetooth. Other configurations are also possible.

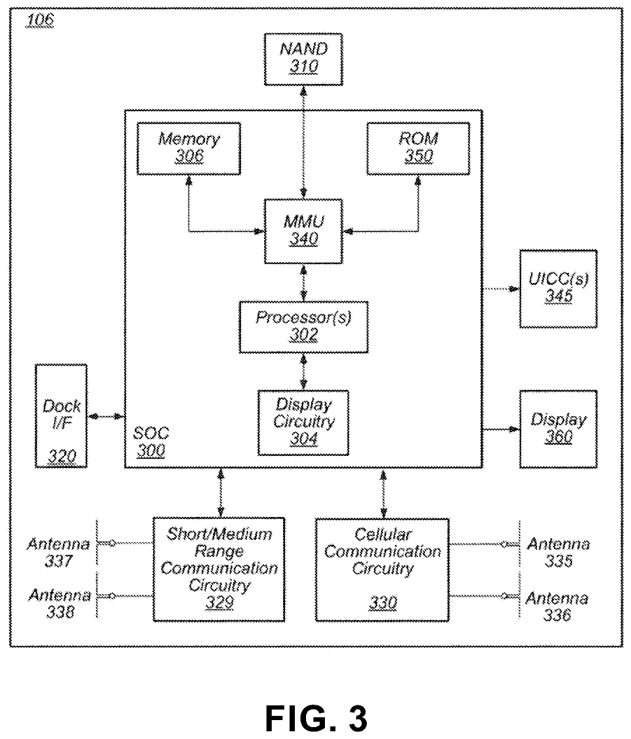

FIG. 3 illustrates an example simplified block diagram of a communication device 106 according to one aspect of the disclosure. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs (component carriers) from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively, (or in addition), processor 302 may be configured as a programmable hardware element, such as an FPGA (Field Programmable Gate Array), or as an ASIC (Application Specific Integrated Circuit). Alternatively, (or in addition), the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

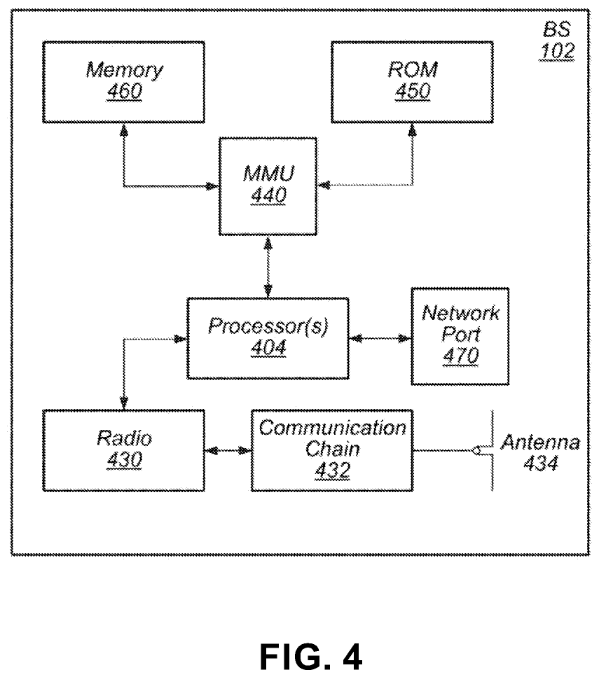

FIG. 4 illustrates an example block diagram of a base station 102 according to one aspect of the disclosure. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UEs 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UEs 106. In some cases, the network port 470 may couple to a telephone network via the core network, and/or the core network may provide a telephone network (e.g., among other UEs serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UEs 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively, (or in addition), the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

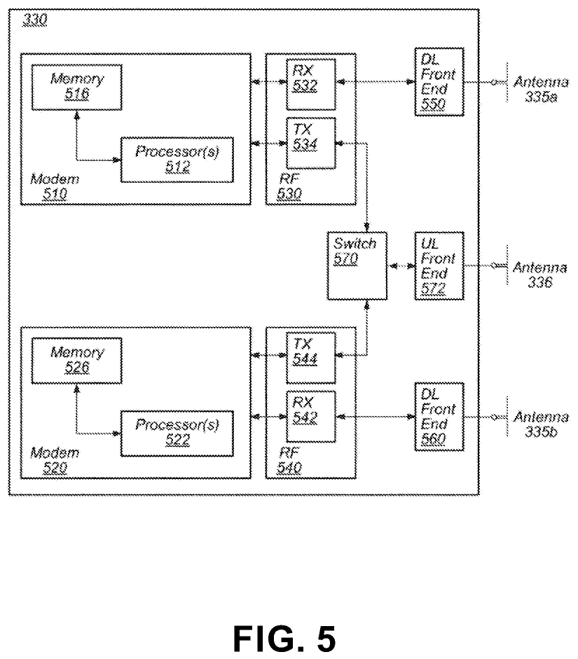

FIG. 5 illustrates an example simplified block diagram of cellular communication circuitry according to one aspect of the disclosure. It is noted that the block diagram of the cellular communication circuitry of FIG. 5 is only one example of a possible cellular communication circuit. According to embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some embodiments, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for selecting a periodic resource part for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively, (or in addition), processor 512 may be configured as a programmable hardware element, such as an FPGA (Field Programmable Gate Array), or as an ASIC (Application Specific Integrated Circuit). Alternatively, (or in addition), the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for selecting a periodic resource on a wireless link between a UE and a base station, as well as the various other techniques described herein. The processors 522 may be configured to implement part or all of the features described herein, e.g., by executing program instructions stored on a memory medium (e.g., a non-transitory computer-readable memory medium). Alternatively, (or in addition), processor 522 may be configured as a programmable hardware element, such as an FPGA (Field Programmable Gate Array), or as an ASIC (Application Specific Integrated Circuit). Alternatively, (or in addition), the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

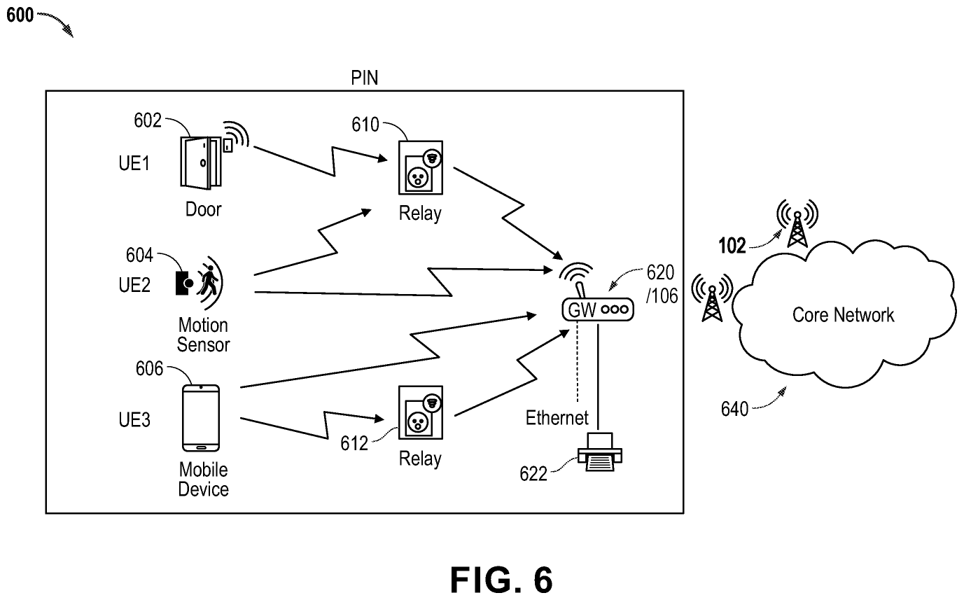

FIG. 6 illustrates a scenario for a gateway 620 in a Personal Internet of Things (IoT) network (a PIN network) 600 to communicate with a core network 640 in a wireless communication network to register and authenticate the gateway 620 and a plurality of UEs.

Referring briefly to FIG. 6, the PIN 600 includes a multitude of PIN Elements (PINEs), which may also be considered UEs. As has been described, a PIN Element (PINE) may be considered to be a basic component making up a PIN-a User's Personal IoT Network. A PINE may be an IoT Device, a UE, or any type of device that communicates within the PIN network, with other PINEs, and through a gateway 620 to an outside core network 640. As has been described, it should be appreciated that the Internet of Things (IoT) describes the network of physical objects—“things”—IoT devices that are embedded with sensors, software, and other technologies for the purpose of connecting and exchanging data with other devices and systems over wired networks, wireless networks, the Internet, etc. Thus, an IoT device may be most any type of computing device. Localized personal IoT devices such as wearable devices and home automation devices are increasing being used in Personal IoT networks (PINs). For example, a wide variety of wearable IoT devices can be locally used: glasses frames, earbuds, blood pressure monitor, pacemaker, rings. Common IoT devices include: wireless sensor networks, control system networks, “smart home” devices-including devices and appliances (such as, lighting fixtures, thermostats, home security systems, cameras, and other home appliances). This being a very small limited example list of IoT devices for use in a PIN.

As an example with reference to FIG. 6, in this PIN 600 example, the PIN 600 includes PINEs: UE1/door 602, UE2/motion sensor 604, and UE3/mobile device 606. These PINEs 602, 604, 606 may wirelessly interface with gateway 620 directly or through relays 610, 612. A PINE 622 (e.g., a printer) may be directly connected to gateway 620. It should be appreciated this is merely an example for illustrative purposes.

Gateway 620 may be a PIN Element with a gateway capability that acts as a gateway to wirelessly communicate with a core network 640 including a base station(s) 102. The gateway 620 may also provide access to and from a wide variety of public operator networks (fixed/mobile/cable). In this example, gateway 620 may be a PIN element that can have both PIN management capability and gateway capability. Gateway 620 may operate as bridge between IoT devices (602, 604, 606, 622) in the PIN 600 and to the core network 640 cloud, as well as other user equipment, such as, other mobile devices (e.g., smart phones). Therefore gateway 620 may be considered a gateway PINE (denoted as a PINEG).

Even more particularly, as will be described, gateway 620 may communicate with core network 640 in a wireless communication network to register and authenticate the gateway 620 and the plurality of UEs (602, 604, 606, etc.) of the PIN 600 in an optimized manner. It should be appreciated that gateway 620 may be a UE 106 as previously described and that devices 602, 604, 606 may also operate with structure and functions as previously described UE 106. In the following description, the terms “IoT devices” and “UEs” may be used interchangeably. Also, in the following description, the terms “base station” and “network” may be used interchangeably.

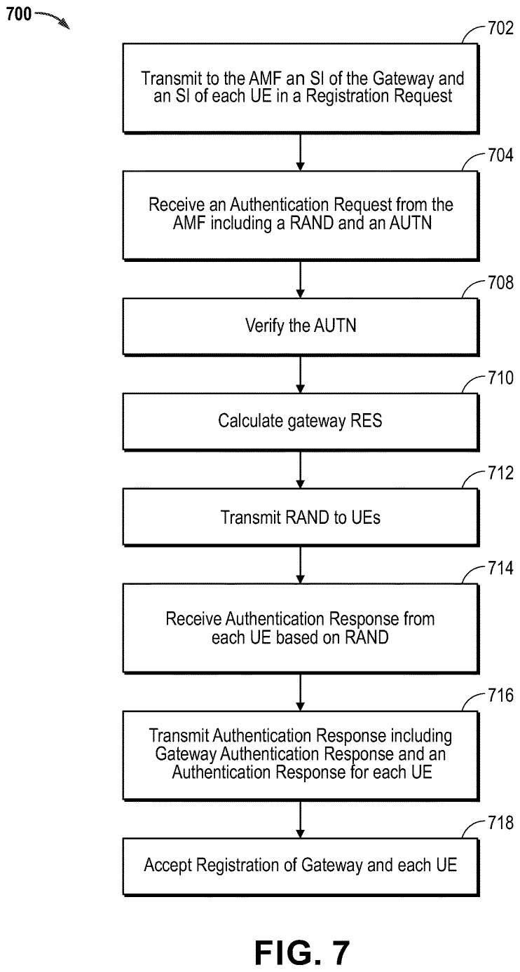

With brief reference to FIG. 7, FIG. 7 is a flow chart illustrating a process for the gateway 620 to register and authenticate IoT devices and UEs (e.g., 602, 604, 606) with the core network 640. It should be appreciated the core network includes an access mobility function entity (AMF). In this example embodiment, a method 700 to authenticate a plurality of user equipments (UEs) with an access mobility function entity (AMF) of a core network of a communication network is disclosed. To begin with the method includes: transmitting to the AMF of the communication network a subscriber identifier (SI) of a gateway and a SI for each of the plurality of user equipments (UEs) in a registration request (block 702). Next, the process includes receiving an authentication request from the AMF including a random number (RAND) and an authentication token, in which, the RAND is associated with both the gateway and the UEs. Next, the process verifies the authentication token (block 708) and calculates a gateway authentication response (block 710). The process then transmits the RAND to all of the UEs (block 712). The process then: receives an authentication response from each of the UEs based on the RAND (block 714) and transmits an authentication response to the AMF including the gateway authentication response and the authentications responses from each of the UEs (block 716). After this, the process accepts registration of the gateway and the plurality of UEs by the AMF of the core network (block 718).

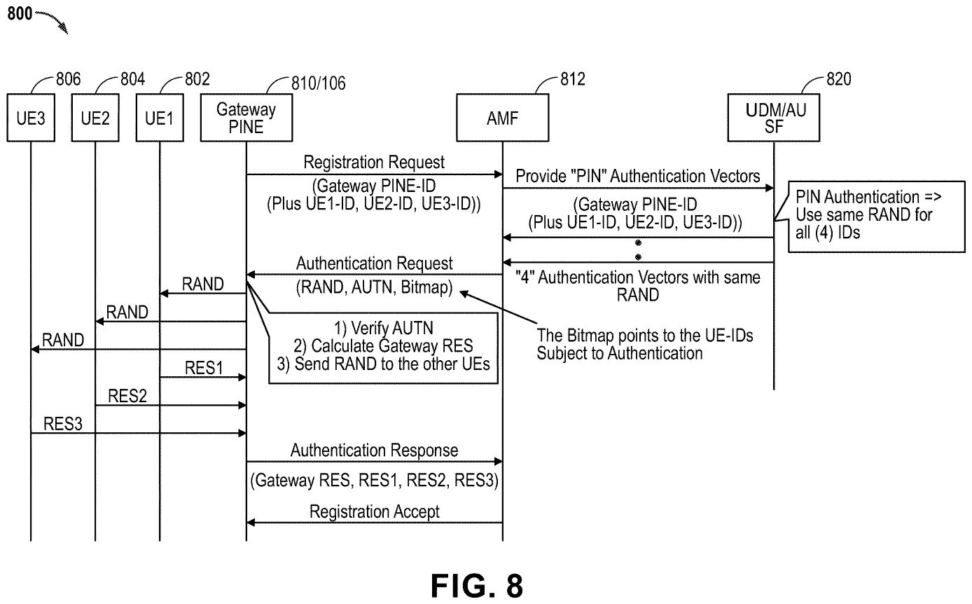

With reference now to FIG. 8, FIG. 8 is a more detailed flow diagram illustrating a process 800 for a gateway 810 to register and authenticate IoT devices and UEs (e.g., 802, 804, 806) with an AMF 812 of the core network 640. As shown in FIG. 8, gateway PINE 810 initiates a registration request. During the registration request, gateway PINE 810 transmits its own subscriber ID (PINE-ID) along with the subscriber IDs for each of the plurality of the other UEs (UE1 802, UE 804, UE3 806) in the PIN to the AMF 812. The other PINEs picking the gateway PINE for registration. For example, in a 5G example, these IDs may subscription concealed identifiers/global unique temporary identifiers (SUCI)/5G-GUTI. In one example, these UE-IDs are sent in a sequential order, e.g., UE1-ID, UE2-ID, etc. AMF 812 then sends this request to Unified Data Management/Authentication Server Function entity (UDM/AUSF) 820 of the network. When the AMF 812 sends the request to the UDM/AUSF 820 of the Home Public Land Mobile Network (HPLMN), the AMF informs the HPLMN that all of the UE-IDs (they are Subscription Concealed Identifiers (SUCIs) here) belong to the same PIN. This can be done by either defining a new message, in which all SUCIs will we sent, or sending several requests and creating a linkage between them by means of using a Link-ID, Operation-ID, etc. When this operation is used, the HPLMN UDM/AUSF may use the same RAND for all of these PINE devices belonging to the same PIN and may create the authentication vectors for all of them and then send them to the AMF 812. Subsequently, the HPLMN UDM can provide the real UE IDs, i.e. the Subscription Permanent Identifiers (SUPIs), to the AMF.

The AMF 812 then sends only one RAND in the Authentication Request Message to the gateway pine 810 an only one authentication token (AUTN) corresponding to the gateway's RAND. In addition, the core network also informs the gateway pine 810 that this particular authentication request also applies to one or more PINEs with the corresponding UE-IDs that were provided in the registration request message. The core network may do this by including a bitmap (instead of actual UE-IDs) corresponding to the ones that the core network wishes to authenticate.

Based upon the authentication request received from the AMF 812, the gateway PINE 810 can locally verify the authentication request from the network, according to an authentication token check. Also, the gateway PINE 810 can calculate its gateway response. Once the network has been verified by the gateway pine 810, the gateway pine 810 sends the RAND to all the other PINE devices (UE1 802, UE2 804, UE3 806). All of the PINEs behind the gateway PINE 810 have been configured to rely on the gateway PINE 810 verifying the network based on the authentication token. As an alternative, gateway PINE 810 can simply inform the PINEs it has verified the network. Each PINE device (UE1 802, UE2 804, UE3 806) then calculates its own response (RES1, RES2, RES3) and sends it to the gateway PINE 810.

The gateway PINE 810 then responds to the network by transmitting an authentication response message to AMF 812 that includes a gateway pine response, a UE1 response (RES1), a UE2 response (RES2), and a UE3 response (RES3). The responses from the other PINEs are sent in the same sequential order and based on the same bitmap that the network sent to the gateway PINE 810 in the authentication request message.

A benefit of this process is that, while only one RAND was sent by AMF 812 to the gateway PINE 810, all of the other PINEs (UE1 802, UE2 804, UE3 806) can be authenticated with this same process.

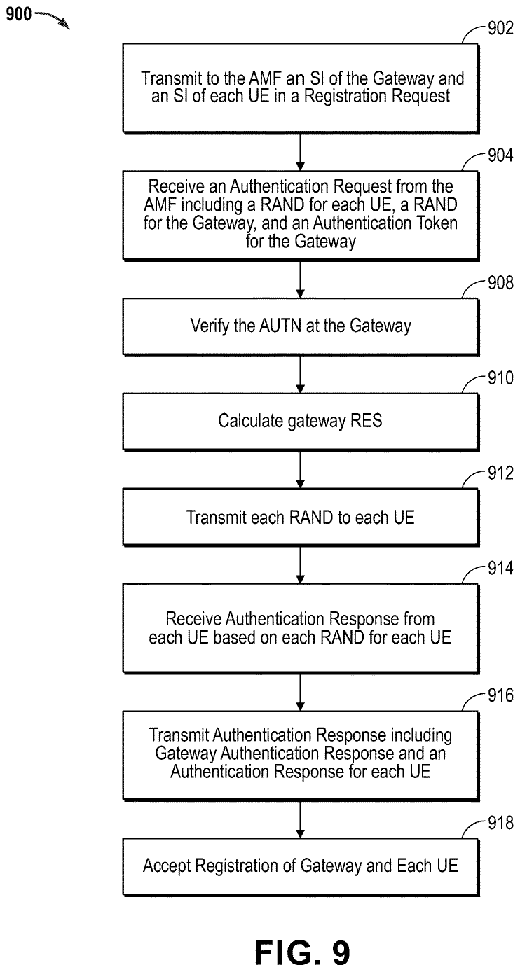

With brief reference to FIG. 9, FIG. 9 is a flow chart illustrating a process 900 for the gateway to register and authenticate IoT devices and UEs with a core network, according to another embodiment. As will be described, this process includes random numbers associated with each UE. In this other example embodiment, a method 900 to authenticate a plurality of user equipments (UEs) with an access mobility function entity (AMF) of a core network of communication network is disclosed. To begin with the method includes: transmitting to the AMF of the communication network a subscriber identifier (SI) of a gateway and a SI for each of the plurality of user equipments (UEs) in a registration request (block 902). Next, the process includes receiving an authentication request from the AMF including a random number (RAND) for each UE, a RAND for the gateway, and an authentication token for the gateway (block 914). Next, the process verifies the authentication token at the gateway (block 908) and calculates a gateway authentication response (block 910). The process then transmits each RAND for each UE to each UE (block 912). The process then: receives an authentication response from each of the UEs based on each RAND for each UE (block 914) and transmits an authentication response to the AMF including the gateway authentication response and the authentications responses from each of the UEs (block 916). After this, the process accepts registration of the gateway and the plurality of UEs by the AMF of the core network (block 918).

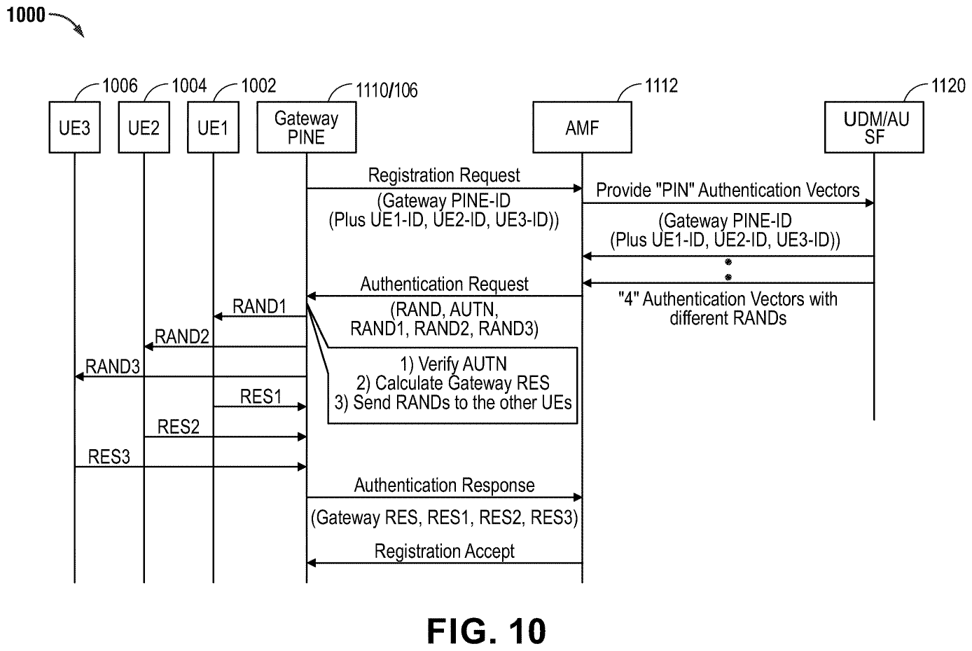

With reference now to FIG. 10, FIG. 10 is a more detailed flow diagram illustrating a process 1000 for a gateway 1110 to register and authenticate IoT devices and UEs (e.g., 1002, 1004, 1006) with an AMF 1112 of the core network. As shown in FIG. 10, gateway PINE 1110 initiates a registration request. During the registration request, gateway PINE 1110 transmits its own subscriber ID (PINE-ID) along with the subscriber IDs for each of the plurality of the other UEs (UE1 1002, UE 1004, UE3 1006) in the PIN to the AMF 1112. The other PINEs picking the gateway PINE for registration.

For example, in a 5G example, these IDs may be subscription concealed identifiers/global unique temporary identifiers (SUCI/5G-GUTI). In one example, these UE-IDs are sent in a sequential order, e.g., UE1-ID, UE2-ID, etc. AMF 1112 then sends this request to Unified Data Management/Authentication Server Function entity (UDM/AUSF) 1120 of the network. When the AMF 1112 sends the request to the UDM/AUSF 1120 of the Home Public Land Mobile Network (HPLM), the AMF informs the HPLMN that all of the UE-IDs (they are Subscription Permanent Identifiers (SUPIs) here) belong to the same PIN. This can be done by either defining a new message, in which all SUPIs will we sent, or sending several requests and creating a linkage between them by means of using a Link-ID, Operation-ID, etc. When this operation is used, the HPLMN UDM/AUSF may use the different RANDs for each of the PINE devices belonging to the same PIN and may create the authentication vectors for all of them and then send them to the AMF 1112.

AMF 1112 then sends the different RANDs, each belonging to one PINE in the authentication request to the gateway pine 1110. For example, the authentication request to the gateway pine 1110 may include the regular RAND corresponding to the gateway pine and then RANDs sent as new IEs for each UE, such as: RAND1 for UE1, RAND2 for UE2, RAND3 for UE3. However, AMF 112 only includes one authentication token (AUTN) corresponding to the gateway pine's 1110 RAND for the gateway pine 1110. In this embodiment, only the gateway pine 1110 verifies the network by locally checking the AUTN. Based upon the authentication request received from the AMF 1112, the gateway PINE 1110 can locally verify the authentication request from the network, according to an authentication token parameter check. Also, the gateway PINE 1110 can calculate is gateway response.

Once the network has been verified by the gateway pine 1110, the gateway pine 1110 will send the different RANDs to each PINE associated with it (e.g., RAND1 to UE1, RAND2 to UE2, RAND3 to UE3). In this communication, the gateway pine 1110 informs the PINEs 1002, 1004, and 1006, that it has verified the network.

Each PINE device (UE1 1002, UE2 1004, UE3 1006) then calculates its own response (RES1, RES2, RES3) and sends it to the gateway PINE 1110. The gateway PINE 1110 then responds to the network by transmitting an authentication response message to AMF 1112 that includes a gateway pine response, a UE1 response (RES1), a UE2 response (RES2), and a UE3 response (RES3). The responses from the other PINEs are sent in the same sequential order that the network sent to the gateway PINE 810 in the authentication request message.

In some embodiments, in case the number of PINEs behind the gateway become very high, leading to the authentication response message getting too long, the gateway can send more than one authentication response to the network. When doing so, the subsequent authentication response messages may be linked to the first and will contain the RES(s) in the same order as above. These subsequent messages will also have a new IE to inform the network which message (e.g., message number 3) is being sent and which message is the last message. Using the method, in case one message is lost, the network can simply ask the PINE gateway to retransmit that particular one. Moreover, the network can find out when the sequence is over.

Therefore, as has been previously described, in an example embodiment, a gateway of a communication network is disclosed that includes: at least one antenna; at least one radio, in which, the at least one radio is configured to communicate with the communication network using the at least one antenna, and at least one processor coupled to the at least one radio. The at least one processor may be configured to perform operations including: transmitting to an access mobility function (AMF) entity a subscriber identifier of the gateway and a subscriber identifier for each of a plurality of user equipments (UEs) in a registration request; receiving an authentication request from the AMF including a random number (RAND) and an authentication token, wherein the RAND is associated with both the gateway and the UEs; verifying the authentication token; calculating a gateway authentication response; and transmitting the RAND to the UEs. The processor of the gateway further: receives an authentication response from each of the UEs based on the RAND; transmits an authentication response to the AMF including the gateway authentication response and the authentications responses from each of the UEs; and then accepts registration of the gateway and the plurality of UEs by the AMF entity. In this example embodiment, a single RAND is utilized. In another embodiment, previously described, a specific RAND number may be associated with each UE specifically.

Further, as has been previously described, in another example embodiment a user equipment (UE) in the PIN (e.g., a IoT) may include: at least one antenna; at least one radio, wherein the at least one radio is configured to communicate with a communication network using the at least one antenna; and at least one processor coupled to the at least one radio is disclosed. The at least one processor may be configured to perform operations including: receiving a random number (RAND) from a gateway, wherein, the RAND is received from the gateway in an authentication request from an access mobility function entity (AMF) of a communication network, wherein, the RAND is associated with both the gateway, the UE, and a plurality of other UEs associated with the gateway based upon a registration request from the gateway to the AMF including subscriber identifiers of the gateway, the UE, and the plurality of other UEs; computing an authentication response to the AMF based upon the RAND; and transmitting the authentication response to the gateway, wherein the gateway transmits an authentication response to the AMF that includes an authentication response of the gateway and authentication responses of the UEs. In another embodiment, previously described, a specific RAND number may be associated with each UE specifically.

It should be appreciated that gateway pines, as previously described, may be a UE 106, as previously described, utilizing a processor, antenna, radio, etc., as previously described, to perform its previously described functions. Further, IoTs or other types of UEs in the PIN may similarly be a UE 106, as previously described, utilizing a processor, antenna, radio, etc., as previously described, to perform their previously described functions. However, it should be appreciated that specific types of IoTs in the PIN network may have other types of processor and communication technologies. Therefore, as has been described, the terms “IoT devices” and “UEs” have been used interchangeably. Also, in the previous description, the terms “base station” and “network” have been used interchangeably. Also, baseband processors of the UE and base station have been previously described. It should also be appreciated that a baseband processor of the gateway, UE, IoT, etc., may implement the previously described functions.

The previously described methods, processes, gateways, UEs and IoTs, enhance and optimize authentication and security procedures for personal IoT networks (PINs) in a communication network. In particular, by utilizing the previously described implementations, several devices (e.g., gateways, UEs, PINEs) may be authenticated during one and the same procedure—instead of running several parallel separate procedures as is currently done—by utilizing the previously described device enhancements and modifying the signaling procedures, as has been previously described.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

For example, the described operations may be stored as instructions on a non-transitory computer readable medium for execution by a computer. The computer may execute the instructions to receive from a communication network configuration information for measuring and reporting downlink channel characteristics, measure channel characteristics of a downlink beam from the communication network to generate channel measurements based on the configuration information, report the channel measurements to the communication network to enable the communication network to adapt the downlink beam as a multicast beam to provide multicast service to the UE and other UEs of a multicast group, and receive the multicast beam from the communication network to receive the multicast service.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

1. A gateway of a communication network comprising:
at least one antenna;
at least one radio, wherein the at least one radio is configured to communicate with a communication network using the at least one antenna; and
at least one processor or baseband processor coupled to the at least one radio, wherein
the at least one processor or baseband processor is configured to perform operations comprising:
transmitting to an access mobility function entity (AMF) of the communication network a subscriber identifier of the gateway and a subscriber identifier for each of a plurality of user equipments (UEs) in a registration request;
receiving an authentication request from the AMF including a random number (RAND) and an authentication token, wherein the RAND is associated with both the gateway and the UEs;
verifying the authentication token;
calculating a gateway authentication response;
transmitting the RAND to the UEs;
receiving an authentication response from each of the UEs based on the RAND;
transmitting an authentication response to the AMF including the gateway authentication response and the authentications responses from each of the UEs; and
accepting registration of the gateway and the plurality of UEs by the AMF of the communication network.

2. The gateway of claim 1, wherein the plurality of UEs and the gateway are configured to communicate in a Personal IoT Network (PIN).

3. The gateway of any of the claims 1, wherein the subscriber identifiers for each of the plurality of UEs are transmitted to the AMF of the communication network in the registration request in a sequential order.

4. The gateway of any of the claims 1, wherein the authentication token is verified by implementing an authentication token parameter check.

5. The gateway of any of the claims 1, wherein the authentication request from the AMF further comprises a bitmap identifying UEs to be authenticated in a sequential order.

6. The gateway of claim 5, wherein the authentication response transmitted to the AMF including the gateway authentication response and the authentications responses from each of the UEs includes the responses from the UEs ordered in the same sequential order as in the bitmap of the authentication request.

7. A method to authenticate a plurality of user equipments (UEs) with an access mobility function entity (AMF) of a communication network comprising:
transmitting to the AMF of the communication network a subscriber identifier of a gateway and a subscriber identifier for each of the plurality of user equipments (UEs) in a registration request;
receiving an authentication request from the AMF including a random number (RAND) and an authentication token, wherein the RAND is associated with both the gateway and the UEs;
verifying the authentication token;
calculating a gateway authentication response;
transmitting the RAND to the UEs;
receiving an authentication response from each of the UEs based on the RAND;
transmitting an authentication response to the AMF including the gateway authentication response and the authentications responses from each of the UEs; and
accepting registration of the gateway and the plurality of UEs by the AMF of the communication network.

8. The method of claim 7, wherein the plurality of UEs and the gateway are configured to communicate in a Personal IoT Network (PIN).

9. The method of any of the claims 7, wherein the subscriber identifiers for each of the plurality of UEs are transmitted to the AMF of the communication network in the registration request in a sequential order.

10. The method of any of the claims 7, wherein the authentication token is verified by implementing an authentication token parameter check.

11. The method of any of the claims 7, wherein the authentication request from the AMF further comprises a bitmap identifying UEs to be authenticated in a sequential order.

12. The method of claim 11, wherein the authentication response transmitted to the AMF including the gateway authentication response and the authentications responses from each of the UEs includes the responses from the UEs ordered in the same sequential order as in the bitmap of the authentication request.

13. A processor of a wireless user equipment (UE) of a communication network configured to:
receive a random number (RAND) from a gateway, wherein, the RAND is received from the gateway in an authentication request from an access mobility function entity (AMF) of the communication network, wherein, the RAND is associated with both the gateway and UEs associated with the gateway based upon a registration request from the gateway to the AMF including subscriber identifiers of the gateway, the UE, and the plurality of other UEs;
compute an authentication response to the AMF based upon the RAND, and
transmit the authentication response to the gateway, wherein the gateway transmits an authentication response to the AMF, wherein the authentication response includes an authentication response of the gateway and authentication responses of the UEs.

14. The processor of claim 13, wherein the UE, the plurality of other UEs, and the gateway are configured to communicate in a Personal IoT Network (PIN).

15. The processor of any of the claims 13, wherein the subscriber identifiers for the UE and the plurality of other UEs in the registration request to the AMF of the communication network are in a sequential order.

16. The processor of any of the claims 13, wherein the authentication request from the AMF further comprises a bitmap identifying UEs to be authenticated in a sequential order.

17. The processor of any of the claims 13, wherein the processor is a baseband processor.

18. A gateway of a communication network comprising:
at least one antenna;
at least one radio, wherein the at least one radio is configured to communicate with a communication network using the at least one antenna; and
at least one processor or baseband processor coupled to the at least one radio, wherein the at least one processor is configured to perform operations comprising:
transmitting to an access mobility function entity (AMF) of the communication network a subscriber identifier of a gateway and a subscriber identifier for each of a plurality of user equipments (UEs) in a registration request;
receiving an authentication request from the AMF including a RAND associated with the gateway, a random number (RAND) associated with each UE, respectively, and an authentication token corresponding to the RAND associated with the gateway;
verifying the authentication token;
calculating a gateway authentication response;
transmitting each RAND associated with each UE, to each UE, respectively;
receiving an authentication response from each of the UEs, based on each UE's RAND;
transmitting an authentication response to the AMF including the gateway authentication response and the authentication responses from each of the UEs, respectively; and
accepting registration of the gateway and the plurality of UEs by the AMF of the communication network.

19. The gateway of claim 18, wherein the plurality of UEs and the gateway are configured to communicate in a Personal IoT Network (PIN).

20. The gateway of any of the claims 18, wherein the subscriber identifiers for each of the plurality of UEs are transmitted to the AMF of the communication network in the registration request in a sequential order.

21. The gateway of any of the claims 18, wherein the authentication token is verified by implementing an authentication token parameter check.

22. The gateway of any of the claims 18, wherein, after the authentication token is verified, the UEs are informed that the authentication token was verified.

23. A method to authenticate a plurality of user equipments (UEs) with an access mobility function entity (AMF) of a communication network comprising:
transmitting to the AMF of the communication network a subscriber identifier of a gateway and a subscriber identifier for each of the plurality of user equipments (UEs) in a registration request;
receiving an authentication request from the AMF including a RAND associated with the gateway, a random number (RAND) associated with each UE, respectively, and an authentication token corresponding to the RAND associated with the gateway;
verifying the authentication token at the gateway;
calculating a gateway authentication response;
transmitting each RAND associated with each UE, to each UE, respectively;
receiving an authentication response from each of the UEs, based on each UE's RAND;
transmitting an authentication response to the AMF including the gateway authentication response and the authentication responses from each of the UEs, respectively; and
accepting registration of the gateway and the plurality of UEs by the AMF of the communication network.

24. The method of claim 23, wherein the plurality of UEs and the gateway are configured to communicate in a Personal IoT Network (PIN).

25. The method of any of the claims 23, wherein the subscriber identifiers for each of the plurality of UEs are transmitted to the AMF of the communication network in the registration request in a sequential order.

26. The method of any of the claims 23, wherein the authentication token is verified by implementing an authentication token parameter check and after the authentication token is verified, the UEs are informed that the authentication token was verified.

27. A processor of a wireless user equipment (UE) of a communication network configured to:
receive a random number (RAND) associated with the UE, wherein, the RAND for the UE is received from the gateway in an authentication request from an access mobility function entity (AMF) of a communication network based upon a registration request from the gateway to the AMF including subscriber identifiers of the gateway, the UE, and the plurality of other UEs;
compute an authentication response to the AMF based upon the RAND; and
transmit the authentication response to the gateway, wherein the gateway transmits an authentication response to the AMF, wherein the authentication response includes an authentication response of the gateway and authentication responses of the UEs.

28. The processor of claim 27, wherein the subscriber identifiers for each of the plurality of UEs are transmitted to the AMF of the communication network in the registration request in a sequential order and after the authentication token is verified by the gateway, the UE is informed that the authentication token was verified.

29. The processor of any of the claims 27, wherein the processor is a baseband processor.
